(19) United States
(12) Patent Application Publication
(10) Pub. No.: US 2014/0068468 A1
(43) Pub. Date: Mar. 6, 2014

(54) USER INTERFACE APPARATUS AND METHOD FOR MANAGING SUBGROUP OF CONVERSATION GROUP

(71) Applicant: PANTECH CO., LTD., Seoul (KR)

(72) Inventor: Ji-Sun YOON, Seoul (KR)

(73) Assignee: PANTECH CO., LTD., Seoul (KR)

(21) Appl. No.: 13/975,913

(22) Filed: Aug. 26, 2013

(30) Foreign Application Priority Data
Aug. 31, 2012 (KR) 10-2012-0096714

(51) Int. Cl. H04L 29/06

(52) U.S. Cl. CPC H04L 65/403
USPC 715/758

(57) ABSTRACT

A new interface specialized in a group conversation and/or a group chatting, a user interface apparatus, and a method for efficiently generating a new conversation window during a group conversation using a subgroup of a conversation group are provided. A method includes displaying a group conversation window on a display screen of an apparatus, the group conversation window being associated with a plurality of participants, in response to receiving a selection input, selecting a subgroup from among the plurality of participants, the selection input being received when at least part of the group conversation window is displayed on the display screen, and displaying a subgroup conversation window associated with the selected subgroup.

### CROSS-REFERENCE TO RELATED APPLICATIONS

This application claims priority from and the benefit under 35 U.S.C. §119(a) of Korean Patent Application No. 10-2012-0096714, filed on Aug. 31, 2012, which is incorporated herein by reference as if fully set forth herein.

### BACKGROUND

1. Field

The following description relates to an apparatus and a method for providing a user interface and, more specifically, to a user interface apparatus and a method of a mobile terminal.

2. Discussion of the Background

Before the advent of evolved mobile terminals, a messenger that provides a conversation function with other people in real time was used largely in a personal computer (PC). However, the messenger is now available in a mobile terminal due to a rapid development of mobile terminals, such as a smart phone. In particular, as people tend to carry their mobile terminal all the day, more and more people use messenger services provided by mobile terminals. Under this circumstance, various types of messenger applications have been developed.

A messenger program enables users to check online status of their messenger friends and receive a response immediately. In addition, using a messenger program that provides a file exchange function, the users are able to have not only a one-to-one conversation with one person but also a group conversation with a group of people.

A method for utilizing a group conversation using a messenger is forming a group of three or more people and generating one conversation window. In this case, if a user wishes to generate another conversation window to chat with a specific person or a subgroup during a group conversation, the user has to go back to a user list and then generate a new conversation window. Since the conventional method requires a user to check a user list in a different window hierarchy whenever the user wants to have a one-to-one conversation with a specific person during a group conversation, it may cause an inconvenience in switching between group communication and subgroup communication.

### SUMMARY

Exemplary embodiments of the present invention provide an apparatus and method for providing a user interface capable of creating and managing one or more subgroups is of a conversation group. According to aspects of the present invention, subgroup management may be more efficiently performed in a conversation group window by providing a subgroup managing user interface.

Additional features of the invention will be set forth in the description which follows, and in part will be apparent from the description, or may be learned by practice of the invention.

Exemplary embodiments of the present invention provide a method, including: displaying a group conversation window on a display screen of an apparatus, the group conversation window being associated with a plurality of participants; in response to receiving a selection input, selecting a subgroup from among the plurality of participants, the selection input being received when at least part of the group conversation window is displayed on the display screen; and displaying a subgroup conversation window associated with the selected subgroup.

Exemplary embodiments of the present invention provide an apparatus, including: a touch screen display to display a group conversation window, the group conversation window being associated with a plurality of participants, and to receive a selection input, the selection input being received when at least part of the group conversation window is displayed on the touch screen display; and a processor, in response to receiving the selection input, configured to select a subgroup from among the plurality of participants. The touch screen display displays a subgroup conversation window associated with the selected subgroup.

Exemplary embodiments of the present invention provide a non-transitory computer readable storage medium storing one or more programs for instructing a computer, when executed by a processor, to perform: displaying a group conversation window on a display screen of an apparatus, the group conversation window being associated with a plurality of participants; in response to receiving a selection input, selecting a subgroup from among the plurality of participants, the selection input being received when at least part of the group conversation window is displayed on the display screen; and displaying a subgroup conversation window associated with the selected subgroup.

Exemplary embodiments of the present invention provide a user interface including: a first area in which a conversation window for a conversation group is generated; a second area in which a conversation window for a subgroup is generated, a participant profile configured to distinguish each participant of the subgroup and to include personal information about each participant of the subgroup; and a boundary configured to distinguish the first area and the second area and to shift between the first area and the second area by being moved in a left or right direction.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a user interface apparatus for managing a subgroup of a conversation group according to an exemplary embodiment of the present invention.

FIG. 2A is a diagram illustrating an example of a first display screen of a user interface for managing a subgroup of a conversation group according to an exemplary embodiment of the present invention, and FIG. 2B is a diagram illustrating an example of a second display screen of a user interface for managing a subgroup of a conversation group according to an exemplary embodiment of the present invention.

FIG. 3 is a flowchart illustrating a method for adding a participant to a subgroup of a conversation group according to an exemplary embodiment of the present invention.

FIG. 4 is a diagram illustrating an example of a user interface to explain a method for adding a participant to a subgroup of a conversation group according to an exemplary embodiment of the present invention.

FIG. 5 is a flowchart illustrating a method for generating a new conversation window for a subgroup of a conversation group according to an exemplary embodiment of the present invention.

FIG. 6 is a diagram illustrating an example of a user interface to explain a method for generating a new conversation window for a subgroup of a conversation group according to an exemplary embodiment of the present invention.

FIG. 7 is a flowchart illustrating a method for returning from a subgroup conversation window to a group conversation window according to an exemplary embodiment of the present invention.

FIG. 8 is a diagram illustrating an example of a user interface to explain a method for returning from a subgroup conversation window to a group conversation window according to an exemplary embodiment of the present invention.

FIG. 9 is a diagram illustrating an example of a user interface to explain a method for closing a subgroup conversation window according to an exemplary embodiment of the present invention.

FIG. 10 is a flowchart illustrating a method for recalling a stored subgroup of a conversation group to retrieve the subgroup according to an exemplary embodiment of the present invention.

FIG. 11A is a diagram illustrating an example of a user interface to explain a method for recalling a stored subgroup of a conversation group to retrieve the subgroup according to an exemplary embodiment of the present invention, and FIG. 11B is a diagram an example of a user interface to explain a method for managing a subgroup conversation window according to an exemplary embodiment of the present invention.

FIG. 12 is a flowchart illustrating a method for generating a subgroup of a conversation group according to an exemplary embodiment of the present invention.

FIG. 13 is a flowchart illustrating another method for generating a subgroup of a conversation group according to an exemplary embodiment of the present invention.

FIG. 14 is a diagram illustrating another example of a user interface for managing a subgroup of a conversation group according an exemplary embodiment of the present invention.

FIG. 15 is a diagram illustrating another example of a user interface for managing a subgroup of a conversation group according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art.

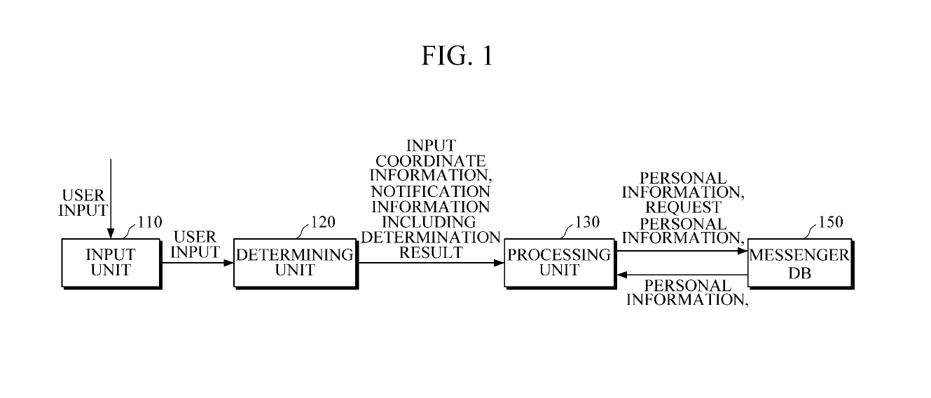

FIG. 1 is a diagram illustrating a user interface apparatus for managing a subgroup of a conversation group according to an exemplary embodiment of the present invention.

Referring to FIG. 1, the user interface apparatus includes an input unit 110, a determining unit 120, a processing unit 130 and a Database (DB) 150. The database 150 may be referred to as a messenger database or a message database.

The input unit 110 may recognize a user input received from a user and transmit the recognized user input to the determining unit 120. The user input 110 may include or may be associated with various types of input interfaces, such as a touch input display, a voice recognition device, a motion sensing device, a conventional keypad, and the like.

The determining unit 120 may determine a type of the received user input. Specifically, if the user input corresponds to a touch input and selects and drags a displayed object, the determining unit 120 recognizes a type of the object and movement (or moving coordinates) of the user input. Using the type of the object and the movement (or moving coordinates) of the user input, the determining unit 120 may be able to determine a type and intention of the user input. The user interface apparatus for managing a subgroup of a conversation group may generate, change and add a subgroup conversation window by selecting and dragging a boundary and a speech bubble. The interfaces associated with the boundary (or “boundary indicator”) and the speech bubble (or “chat balloon”) will be described in more detail.

The determining unit 120 determines the intention of the user input and transmits the determination result to the processing unit 130.

In response to receiving the user input, the determining unit 120 transmits to the processing unit 130 information including movement of the received user input. If the user input is a touch input, coordinates of the user input change when an object is selected and dragged. The determining unit 120 may transmit to the processing unit 130 coordinate information including change of the coordinates.

The processing unit 130 may shift the selected object based on the coordinate information received from the determining unit 120. If a user drags a speech bubble or a boundary, the processing unit 130 may shift the speech bubble or the boundary according to the coordinate information corresponding to the touch input. The processing unit 130 may generate an icon corresponding to the speech bubble. For example, the icon may include information of a contact person corresponding to the speech bubble.

Further, according to the determination result of the determining unit 120 about a type of the received user input, the processing unit 130 may generate, delete, and/or change the subgroup conversation window. Further, according to the determination result of the determining unit 120 about a type of the received user input, the processing unit 130 may add a new participant to the subgroup, or remove a specific participant from the subgroup.

The processing unit 130 may collect personal information stored in database (DB) and store the collected personal information in a DB 150. That is, if a new participant is added to a subgroup, the processing unit 130 may extract information including information, e.g., a picture and a name, of the new participant from the DB 150, such as a previously-stored address list or contact database. If a user selects a specific participant (“contact”), the processing unit 130 may search the previously-stored DB for personal information about the specific participant and collect the personal information including a name, a picture, and a phone number of the specific participant. The user may be effectively informed of the specific participant using the collected personal information, and exchange messages via a messenger program. In addition, the processing unit 130 may store the collected personal information of the specific participant in the DB 150.

The processing unit 130 may divide a conversation window into a group conversation area and a subgroup conversation area. In the group conversation area, all participants, e.g., speech bubbles or conversations of a group, may be displayed.

In response to a control command, the processing unit 130 may further generate and/or display a subgroup conversation window including specific people selected from the group conversation participants. The processing unit 130 may store a participant list of the subgroup and conversations of the generated subgroup and update personal information and conversations of a new or removed subgroup participant. Although a participant is removed from the subgroup, conversations of the removed participant may remain in the subgroup conversation window. Further, in response to the received control command, the processing unit 130 may extract conversations of a specific participant or highlight conversations of the specific participant using a distinguishable font color, a font style or a font effect.

The DB stores the personal information received from the processing unit 130, and a list and conversations of currently-opened conversation windows. The personal information and the list and conversations of currently-opened conversation windows, each stored in the DB 150, may be transmitted to the processing unit 130 in response to a request from the processing unit 130.

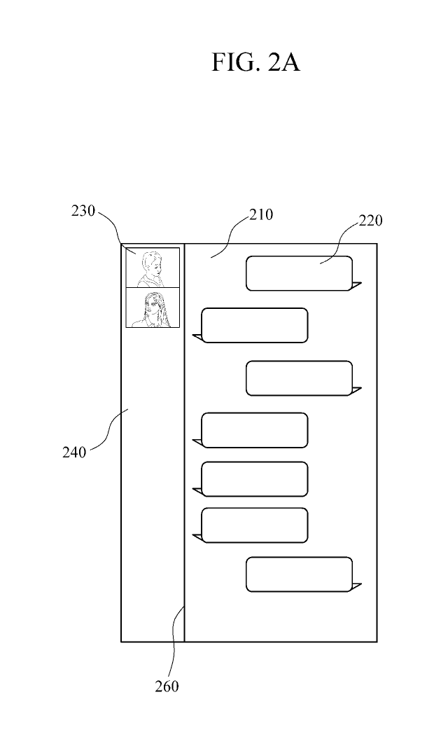

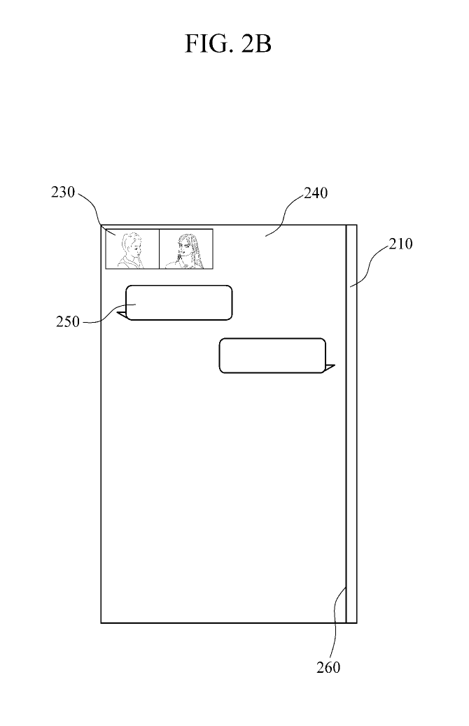

FIG. 2A is a diagram illustrating an example of a first display screen of a user interface for managing a subgroup of a conversation group according to an exemplary embodiment of the present invention, and FIG. 2B is a diagram illustrating an example of a second display screen of a user interface for managing a subgroup of a conversation group according to an exemplary embodiment of the present invention.

Referring to FIG. 2A, the first display screen of a user interface includes a first area 210, group conversation speech bubbles 220, a second area 240, a subgroup profile 230, and a shift interface unit 260.

The first area 210 is an area in which a group conversation window is displayed, and may display the group conversation speech bubbles 220. The group conversation is a method whereby three or more people simultaneously exchange messages on one conversation window via a messenger program.

Each of the group conversation speech bubble 220 may present a message delivered by each of participants of the group conversation.

The second area 240 is an area associated with a subgroup conversation window, and may display the subgroup profile 230 of subgroup participants. The subgroup is a subset group consisting of one or more group conversation participants in the group conversation window.

The subgroup profile 230 displays participants of the subgroup, and may include a picture, a name, and identification (ID) of each participant whose information is stored in DB, such as an address list. In the case of a participant whose personal information is not stored in the DB, the subgroup profile 230 may display a user-set name, a user-set picture, or a default picture.

The shift interface unit 260 is an interface to shift between the first area 210 and the second area 240. In addition, the shift interface unit 260 may be implemented using a boundary between the first area 210 and the second area 240, a button, or a user's touch input. FIG. 2A illustrates an exemplary case where the shift interface unit 260 is a boundary 260. By dragging the boundary 260, a subgroup conversation window may be generated or deleted and the first area 210 and the second area 240 may be shifted from one another. In addition, the boundary may be located on a screen or at an invisible edge of the screen. For example, the subgroup conversation widow may appear and be displayed if the second area 240 is expanded by moving the boundary 260 to the right. The location of the boundary 260 may vary. Further, the second area 240 and/or the boundary 260 may not be displayed. In another example, if the user touches the left edge of the display screen and drags the touch to the right, a display screen for the subgroup conversation window may be displayed (i.e., the subgroup conversation window may replace the group conversation window).

Referring to FIG. 2B, the second display screen of a user interface includes a first area 210, a second area 240, a subgroup profile 230, a shift interface unit 260, and subgroup speech bubbles 250.

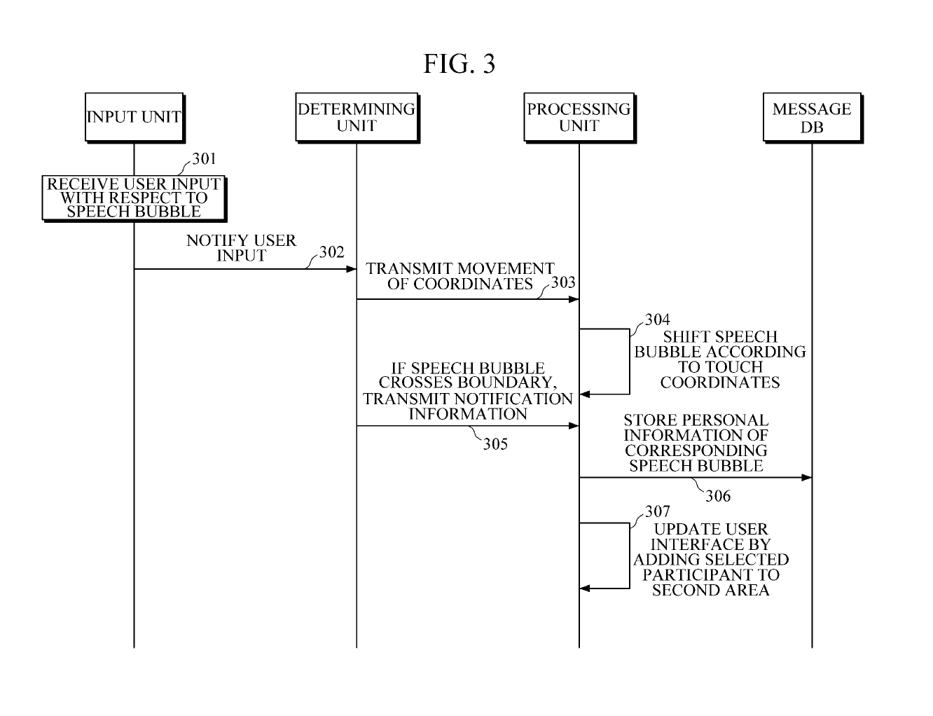

The second area 240 is an area in which a subgroup conversation window is generated, and may display the subgroup profile 230 and the subgroup speech bubbles 250. Each of the subgroup speech bubbles 250 may present a message delivered by each subgroup participant. A method for generating and deleting a subgroup conversation window in the second area 240 and shifting between the first area 210 and the second area 240 will be explained in detail with reference to FIG. 3 through FIG. 10.

In the second area 240, information about a new subgroup that includes people selected by a user from group conversation participants, information about the subgroup participants, the subgroup speech bubbles 250 of the subgroup participants may be displayed. Participants of the first area 210 and the second area 240 may change according to a user input. For example, the first area 210 in FIG. 2B may display information of all participants, e.g., a group profile (not shown) including names or pictures of all participants of the group conversation window. If a user touches a profile, e.g., a picture icon of participant “A”, in the first area 210 and drags the touch input into the second area 240, the participant “A” may be added into the subgroup conversation window and the subgroup profile 230 may further display the profile of the participant “A”. If one profile among the subgroup profile 230 or a speech bubble 250 is touched by a user and dragged into the first area 210, the corresponding participant may be removed from the subgroup and the subgroup profile 230. Further, the boundary 260 and/or the first area 210 may not be displayed. If the user touches the right edge of the display screen and drags the touch to the left direction, a display screen for the group conversation window may be displayed and the second area 240 may disappear (i.e., the group conversation window may replace the subgroup conversation window). In another example, if the boundary 260 is touched by a user and the touch input is dragged to the left, the second area 240 may shrink according to the dragging input or may shrink into a preset size, e.g., the second area 240 shown in FIG. 2A, according to a flicking input to the boundary 260.

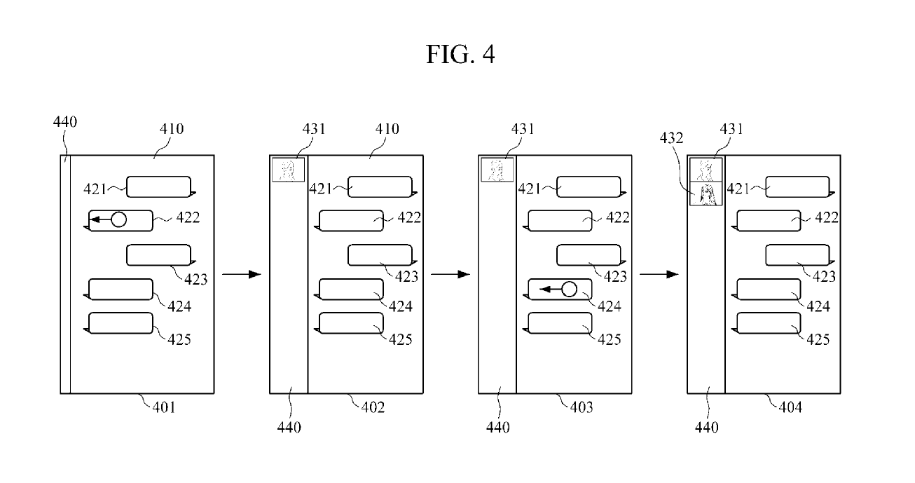

FIG. 3 is a flowchart illustrating a method for adding a participant to a subgroup of a conversation group according to an exemplary embodiment of the present invention. FIG. 3 and FIG. 4 will be described as if performed by the user interface apparatus shown in FIG. 1, but is not limited as such.

Referring to FIG. 3, the method for adding a participant to a subgroup of a conversation group includes: receiving a touch input from a user with respect to a speech bubble of a specific group conversation participant in operation 301. That is, the user may form a subgroup by touching the speech bubble of the specific group conversation participant whom the user wishes to add to the subgroup. For example, the user may touch the speech bubble of the specific participant and then drag the speech bubble from the first area 210 for displaying a group conversation into the second area 240 for displaying a subgroup conversation, so that the specific participant may be added to the subgroup. An input unit 110 detects the user input of dragging the speech bubble. In response to detecting the user input, the input unit 110 notifies a determining unit 120 of detection of the user input in operation 302.

In response to the notification from the input unit 110 of the detection of the user input, the determining unit 120 transmits to a processing unit 130, in operation 303, change of touch coordinates of the user input and information about the dragged speech bubble.

Next, the speech bubble may be shifted to a location corresponding to touch coordinates based on the received change of coordinates in operation 304. That is, the processing unit 130 shifts the selected speech bubble at the touch coordinates on a screen based on the change of touch coordinates and the information about the speech bubble, each received from the determining unit 120.

If the selected speech bubble crosses the boundary between the first area 210 and the second area 240, the determining unit 120 determines that the user input is to add a participant corresponding to the selected speech bubble to a subgroup, and transmits notification information including the determination result to the processing unit 130 in operation 305. That is, if the selected speech bubble is shifted from the first area 210 into the second area 240 by the user input 110, the determining unit 120 determines that the user input is to add the corresponding participant to the subgroup.

In response to receiving the notification information, the processing unit 130 adds personal information of the participant corresponding to the selected speech bubble in the message DB in operation 306. That is, if the selected speech bubble is dragged from the first area 210 to the second area 240, the processing unit 130 determines that the corresponding user input is to add the participant corresponding to the selected speech bubble to the subgroup. Next, the processing unit 130 searches for previously-stored DB for the personal information of the participant and extracts the personal information. The extracted personal information of the participant is added and stored in the messenger DB. The message DB is a local DB allocated to a messenger application, and may store personal information and conversations of people participating in a group conversation or a subgroup conversation. The previously-stored DB may include personal information stored in an address list or in other social network service (SNS) applications.

The processing unit 130 updates a user interface by adding the selected participant to the second area 240 in operation 307. The processing unit 130 adds a name, an ID, or a picture of the selected participant to the subgroup of the second area 240 based on the personal information about the selected participant, and updates a user interface by displaying a profile such that the selected participant is included in the subgroup. If it is determined that the personal information of the selected participant is not stored in DB, an arbitrary picture or ID set by a user or a default image may be displayed in the user interface. With reference to FIG. 4, an example of a user interface may be explained in detail.

FIG. 4 is a diagram illustrating an example of a user interface to explain a method for adding a participant to a subgroup of a conversation group according to an exemplary embodiment of the present invention.

Referring to FIG. 4, the method for adding a participant to a subgroup of a conversation group includes selecting a specific participant's speech bubble from among speech bubbles displayed in a first area 410 and dragging the selected specific speech bubble to a second area 440 in operation 401. The first area 410 is a conversation window for a conversation group, and displays speech bubbles 421, 422, 423, 424, and 425 of group conversation participants. If a user selects a specific participant's speech bubble 422 from the speech bubbles 421, 422, 423, 424, and 425 displayed in the first area 410 and wishes to add the specific participant to the subgroup of the conversation group, the user drags the specific participant's speech bubble 422 from the first area 410 to the second area 440. The second area 440 is an area in which a conversation window for a subgroup of a conversation group may be generated.

A profile of the selected participant is displayed in the second area 440 in operation 402 in response to the addition of the specific participant to the subgroup of the conversation group. If the selected participant's speech bubble 422 is dragged from the first area 410 to the second area 440, the participant's profile 431 is displayed in the second area 440. The profile 431 may include a name, an ID, and/or a picture included in personal information of the participant which is stored in DB 150.

Next, a speech bubble 424 of another selected participant to be added to the subgroup is dragged into the second area 440 in operation 403. That is, the other selected participant may be added to the subgroup by dragging the speech bubble 424 from the first area 410 into the second area 440 in the same manner as described in the operation 401. In addition, the profile 432 of the selected participant is displayed in the second area 440 in operation 404 in response to the addition of the corresponding participant into the subgroup. The profile 432 of the participant may be displayed in the second area 440 in the same manner as described in the operation 402.

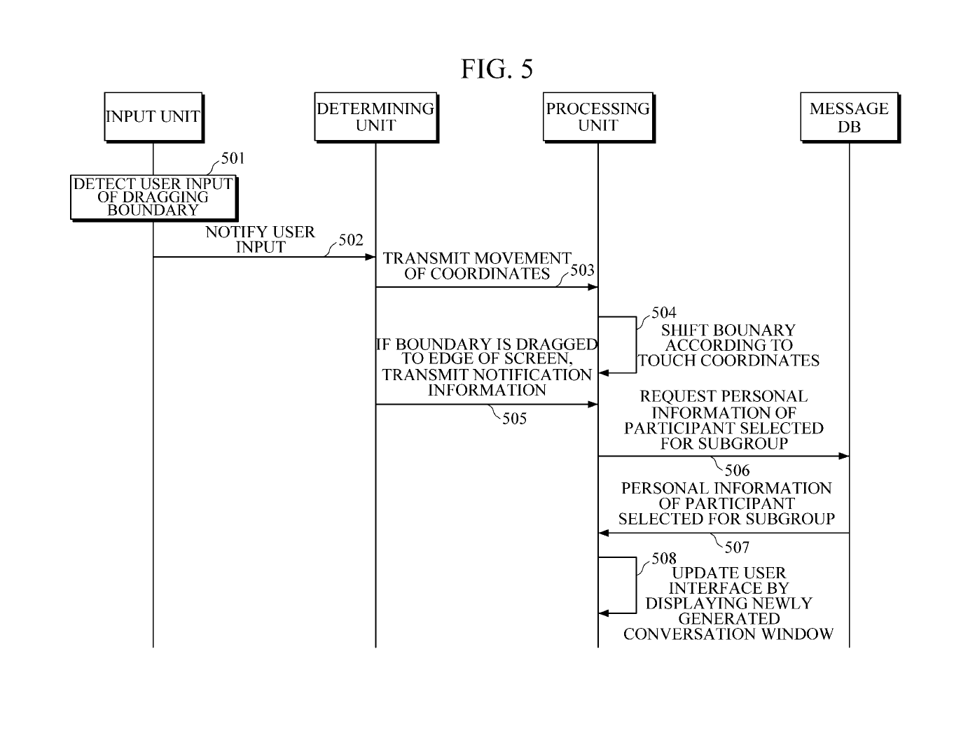

FIG. 5 is a flowchart illustrating a method for generating a new conversation window for a subgroup of a conversation group according to an exemplary embodiment of the present invention. FIG. 5 will be described as if performed by the user interface apparatus shown in FIG. 1, but is not limited as such.

Referring to FIG. 5, the method for generating a new conversation window for a subgroup of a conversation group includes detecting a user input of dragging a boundary between the first area 210 and the second area 240 in operation 501.

A user may generate a new subgroup conversation window by dragging the boundary between the first area 210 and the second area 240 during a group conversation. If the user drags the boundary between the first area 210 and the second area 240 to generate a new subgroup conversation window or retrieve a previously generated subgroup conversation window, an input unit 110 may detect the user input of dragging the boundary. In response to detecting the user input of dragging of the boundary, the input unit 110 notifies a determining unit 120 of detection of the user input of dragging the boundary in operation 502. A method for dragging the boundary may be dragging the boundary itself or using a button or a touch input to move the boundary.

In response to the notification from the input unit 110 of the detection of the user input of dragging the boundary, the determining unit 120 transmits, to a processing unit 130, change of touch coordinates of the user input in operation 503.

Next, the boundary is shifted to a location corresponding to the touch coordinates based on the received information on change of the touch coordinates in operation 504. That is, the processing unit 130 shifts the boundary between the first area 210 and the second area 240 to be located at the touch coordinates based on the received information on change of the touch coordinates from the determining unit 120.

If the boundary is shifted to the edge of a screen, the determining unit 120 determines that the user input is to generate a new subgroup conversation window or to retrieve a generated subgroup window, and transmits notification information including such determination result to the processing unit 130 in operation 505.

Next, the processing unit 130 sends a request to a DB 150 so that the DB 150 transmits personal information about selected people to be added to a subgroup in operation 506, and receives the personal information in operation 507. The requested and transmitted personal information in the operations 506 and 507 may be the personal information about the selected people stored in the DB 150 illustrated in the operation 306.

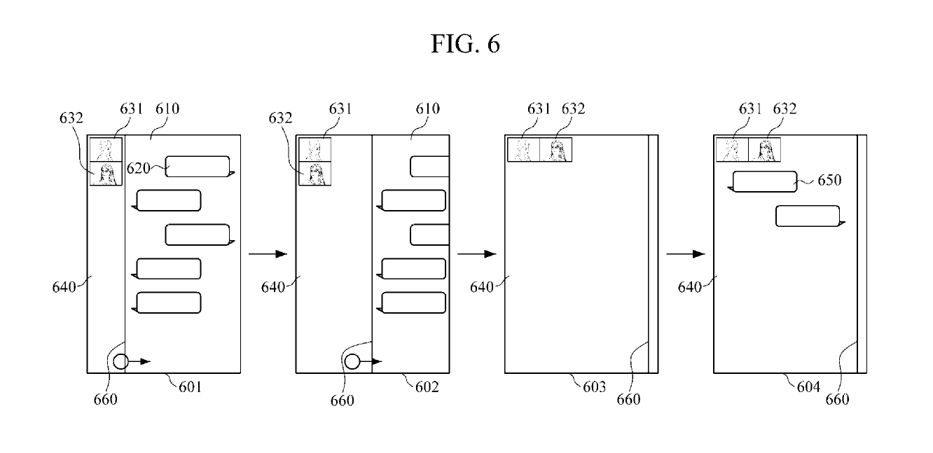

Next, the processing unit 130 updates the user interface by displaying a newly-generated conversation window in operation 508. That is, in response to receiving the user input of dragging the boundary, the processing unit 130 displays the newly-generated conversation window in the user interface using a visual effect of pushing the first area 210 including a main window and expanding the second area 240. With reference to FIG. 6, an example of a user interface will be provided in detail to explain a method for generating a new conversation window or displaying an existing subgroup conversation window.

FIG. 6 is a diagram illustrating an example of a user interface to explain a method for generating a new conversation window for a subgroup of a conversation group according to an exemplary embodiment of the present invention. FIG. 6 will be described as if performed by the user interface apparatus shown in FIG. 1, but is not limited as such.

Referring to FIG. 6, the method for generating a new conversation window for a subgroup of a conversation group includes dragging a boundary 660 between the first area 610 and the second area 640 in a right direction in operations 601 and 602. Speech bubbles 620 displayed on the current user interface screen are displayed in a group conversation window of the first area 610. In order to generate a new subgroup conversation window, the boundary 660 between the first area 610 and the second area 640 is dragged to the right-hand end of a screen. The dragging direction and location of the screen may differ according to arrangement of the first area 610 and the second area 640 or user convenience.

A new conversation window is generated in the second area 640 in operation 603. If the boundary 660 is dragged to the right-hand end of the screen, the first area 610 and group conversation speech bubbles 620 displayed in the first area 610 may be pushed to the outside of the screen and then the new conversation window for the subgroup is generated in the second area 640. However, a method for generating a new conversation window is not limited to dragging of the boundary to the edge of the screen, and may include shifting the boundary by a predetermined distance according to a user's setting. In addition, the method for generating a new conversation window is not limited to pushing the first area 610, and the group conversation speech bubbles 620 of the first area 610 are not limited, and may include dividing the screen into the first area 610 and the second area 640. For example, both the conversation window for the group displayed in the first area 610 and the conversation window for the subgroup displayed in the second area 640 may be displayed in parallel at the same time. Further, by selecting one conversation window from the two conversation windows for the group and the subgroup, the selected conversation window may be activated for receiving message inputs from the user.

Next, subgroup participants exchange messages on the newly-generated conversation window for the subgroup in operation 604. That is, the subgroup participants may exchange messages on the subgroup conversation window of the second area 640 as well as the group conversation window of the first area 610. In the second area 640, profiles of the subgroup 631 and 632 may be displayed. If the second area 640 is expanded and the newly-generated conversation window for the subgroup is displayed in the second area 640, the arrangement of the profiles of the subgroup 631 and 632 may be rearranged horizontally to provide a wider conversation window for the subgroup. Further, although the boundary 660 is displayed in the screens illustrated in operations 603 and 604, the boundary 660 may disappear from the screens and the right edge of the screens may be considered as the boundary 660.

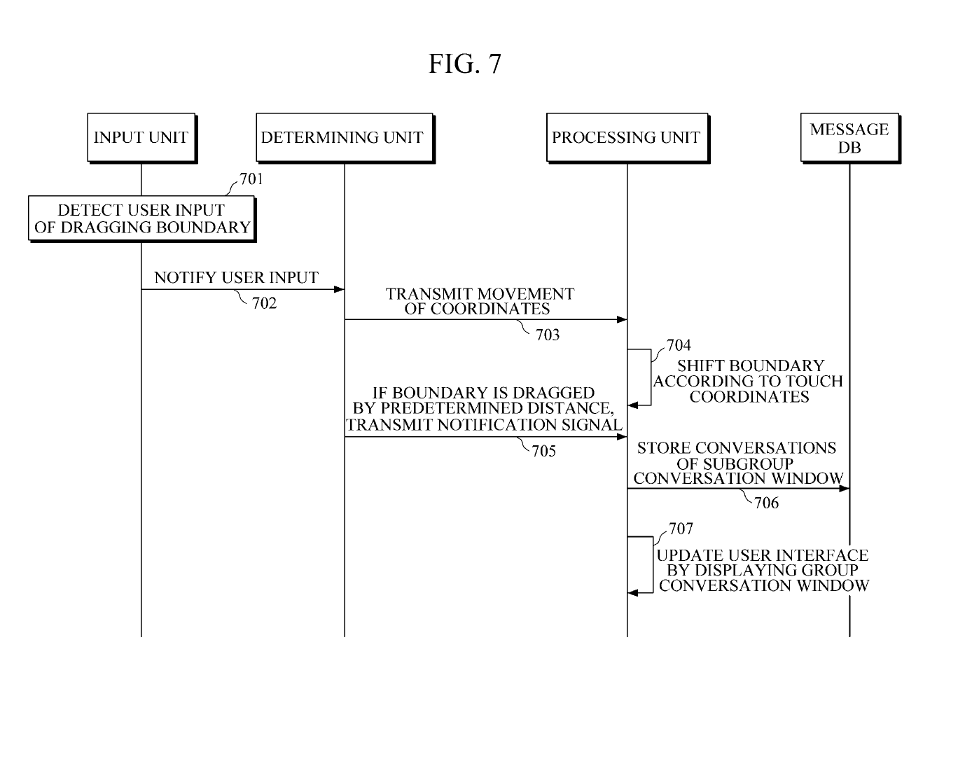

FIG. 7 is a flowchart illustrating a method for returning from a subgroup conversation window to a group conversation window according to an exemplary embodiment of the present invention. FIG. 7 will be described as if performed by the user interface apparatus shown in FIG. 1, but is not limited as such.

Referring to FIG. 7, the method for returning from a subgroup conversation window to a group conversation window includes detecting a user input of dragging a boundary 260 between the first area 210 and the second area 240 in operation 701. A user may return from the subgroup conversation window to the high-order group conversation window by dragging the boundary 260 between the first area 210 and the second area 240 while a subgroup conversation window is being displayed. Specifically, if the user drags the boundary 260 between the first area 210 and the second area 240 in an attempt to return to the group conversation window, an input unit 110 may detect the user input of dragging the boundary 260. The direction of the user input of dragging the boundary 260 may be opposite against that of the other user input described in operation 501 with reference with FIG. 5. In response to detecting the user input of dragging the boundary 210, the input unit 110 notifies a determining unit 120 of the detection of the user input in operation 702.

In response to the notification of the input unit 110 of dragging the boundary 260, the determining unit 120 transmits information on change of touch coordinates of the user input to a processing unit 130 in operation 703.

Next, the boundary 260 is shifted to a location corresponding to the touch coordinates along the received information on change of the touch coordinates in operation 704. That is, the processing unit 130 shifts the boundary 260 between the first area 210 and the second area 240 to be located at the touch coordinates based on the received information on change of the touch coordinates from the determining unit 120.

If the boundary 260 is shifted by a predetermined distance, the determining unit 120 determines that the user input is to return to the group conversation window, and transmits a notification signal including such determination result to the processing unit 130 in operation 705.

Next, the processing unit 130 stores conversations of the subgroup conversation window in a DB 150 in operation 706. Returning back to the high-order group conversation window does not mean deletion of the subgroup conversation window, so that the subgroup conversations, a subgroup participant list, personal information of subgroup participants are stored in the DB 150. Further, subgroup data including the subgroup conversations, a subgroup participant list, personal information of subgroup participants may be stored in the DB 150 in association with the group from which the subgroup is generated.

The processing unit 130 updates the user interface to display the group conversation window in operation 707. In response to receiving the user input of dragging the boundary 260, the processing unit 130 displays the previous group conversation window of the first area 210 using a visual effect of pushing away the second area 240 including the subgroup conversation window.

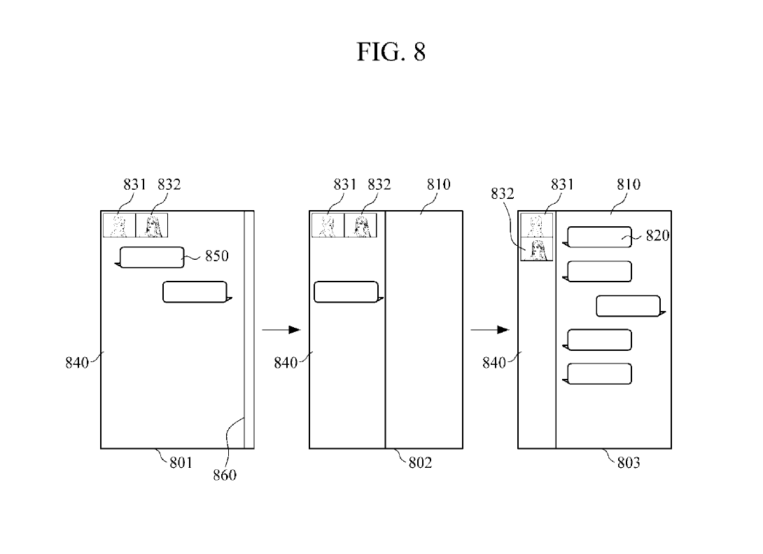

With reference to FIG. 8, an example of a user interface will be provided in detail to explain a method for returning to a group conversation window.

FIG. 8 is a diagram illustrating an example of a user interface to explain a method for returning from a subgroup conversation window to a group conversation window according to an exemplary embodiment of the present invention. FIG. 8 will be described as if performed by the user interface apparatus shown in FIG. 1, but is not limited as such.

Referring to FIG. 8, the method for returning from a subgroup conversation window to a group conversation window includes dragging a boundary 860 between the first area 810 and the second area 840 by a predetermined distance in a left direction in operations 801 and 802. Speech bubbles 850 are currently displayed in the subgroup conversation window of the second area 840. At this time, the boundary 860 between the first area 810 and the second area 840 is dragged by a predetermined distance in a left direction in an attempt to return from the subgroup conversation window to the high-order group conversation window. The dragging direction and location of the screen may differ according to arrangement of the first area 810 and the second area 840 or user convenience.

The group conversation window of the first area 810 appears in operation 803. If the boundary 860 is dragged by a predetermined distance in a left direction of the screen, the subgroup speech bubbles 850 displayed in the second area 840 are pushed to the outside of the screen and then group conversation speech bubbles 820 of the first area 810 appear. In this case, the subgroup conversation window and the subgroup speech bubbles 850 are not removed from the screen. In other words, the subgroup conversation window still exists (stored in the DB 150) but is not displayed in the screen. However, the subgroup conversation window and the subgroup speech bubbles 850 are not limited thereto, and may be deleted, maintained or stored according to settings. According to settings, the boundary 860 between the first area 810 and the second area 840 may be shifted from one another by dragging the boundary by a predetermined distance. In addition, the screen may be divided into the first area 810 and the second area 840 so that the group conversation window and the subgroup conversation window may be displayed on the screen simultaneously as described above with respect to FIG. 6. In the second area 840, profiles of the subgroup 831 and 832 may be displayed. If the second area 840 shrinks and the newly-generated conversation window for the subgroup disappears from the second area 840, the arrangement of the profiles of the subgroup 831 and 832 may be rearranged vertically to provide a wider conversation window for the high-order group. Further, although the boundary 860 is displayed screens illustrated in the operation 801, the boundary 860 may disappear from the screen and the right edge of the screen may be considered as the boundary 860.

Referring to FIG. 6 to FIG. 8, the method for returning from a subgroup conversation window to a group conversation window illustrated in FIG. 8 may be exactly opposite to the method for adding a new conversation window for a subgroup of a conversation group illustrated in FIG. 6. That is, the subgroup conversation window may be generated by dragging the boundary 660 from left to right, and may be returned to the group conversation window by dragging the boundary 860 from right to left. The dragging direction of the boundary is not limited thereto, and may change according to settings.

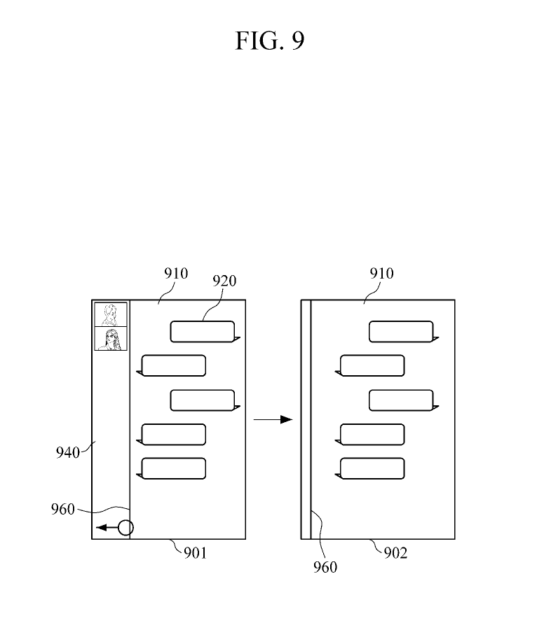

FIG. 9 is a diagram illustrating an example of a user interface to explain a method for closing a subgroup conversation window according to an exemplary embodiment of the present invention.

Referring to FIG. 9, the method for closing a subgroup conversation window includes dragging a boundary 960 between the first area 910 and the second area 920 in a left direction in operation 901. If the boundary 960 is dragged to the left edge of a screen, the dragging operation is recognized as a user input to close or delete the subgroup conversation window in operation 902. If the subgroup conversation window is closed, information of the subgroup conversation may be deleted or stored in the DB 150. Further, although the boundary 960 is displayed in the screens illustrated in operations 901 and 902, the boundary 960 may disappear from the screens and the left edge of the screens may be considered as the boundary 960.

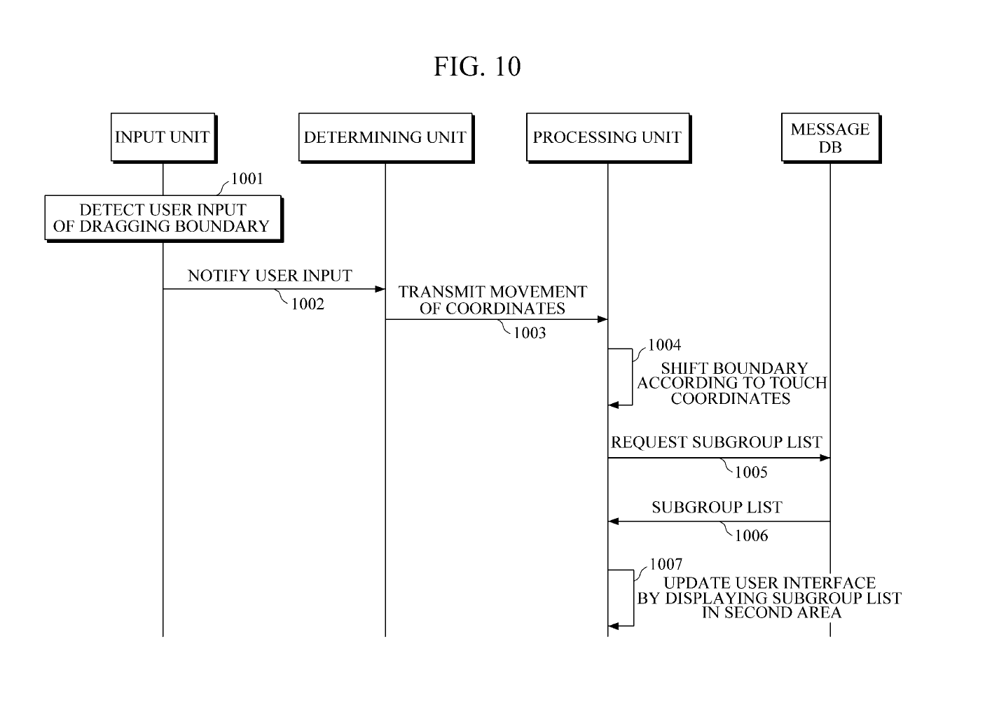

FIG. 10 is a flowchart illustrating a method for recalling a stored subgroup of a conversation group to retrieve the subgroup according to an exemplary embodiment of the present invention. FIG. 10 will be described as if performed by the user interface apparatus shown in FIG. 1, but is not limited as such.

Referring to FIG. 10, the method for recalling a stored subgroup of a conversation group to retrieve the subgroup includes detecting a user input of dragging a boundary between a first area of a display screen for group a conversation window and a second area of the display screen for the group conversation window in operation 1001. During a group conversation, a user may generate a new subgroup conversation window by dragging a boundary between the first area and the second area. In addition, in response to detecting the user input of dragging the boundary, an input unit 110 notifies a determining unit 120 of detection of the user input of dragging the boundary in operation 1002.

In response to the notification by the input unit 110 of the detection of the user input of dragging the boundary, the determining unit 120 transmits, to a processing unit 130, information on change of touch coordinates of the user input.

Next, the boundary is shifted to a location corresponding to the touch coordinates based on and/or along the received information on change of the touch coordinates in operation 1004. That is, the processing unit 130 shifts the boundary between the first area and the second to be located at the touch coordinates based on the received information on change of the touch coordinates.

Next, the processing unit 130 sends a request to the DB 150 so that the DB 150 transmits a stored subgroup list in operation 1005, and then receives the stored subgroup list in operation 1006. If there is no selected person to be added to the subgroup of the second area, the processing unit 130 may recall a subgroup list previously stored in the DB 150.

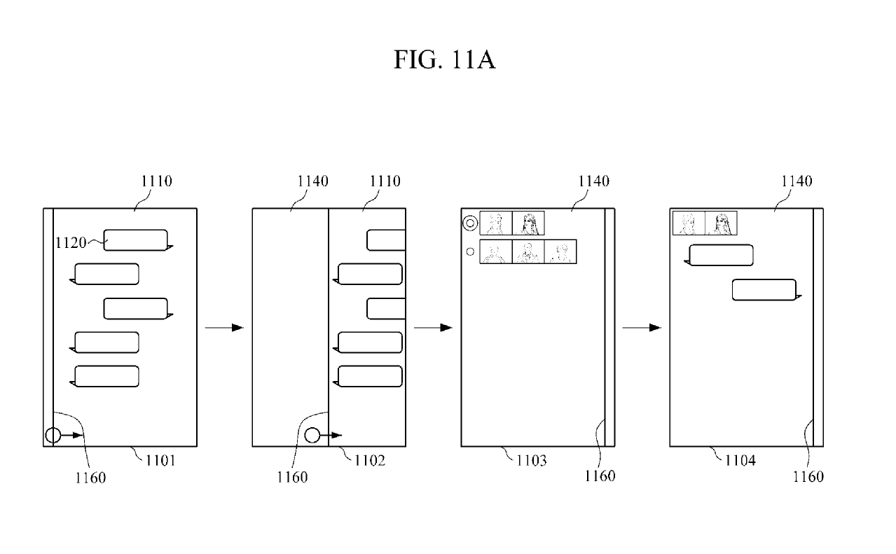

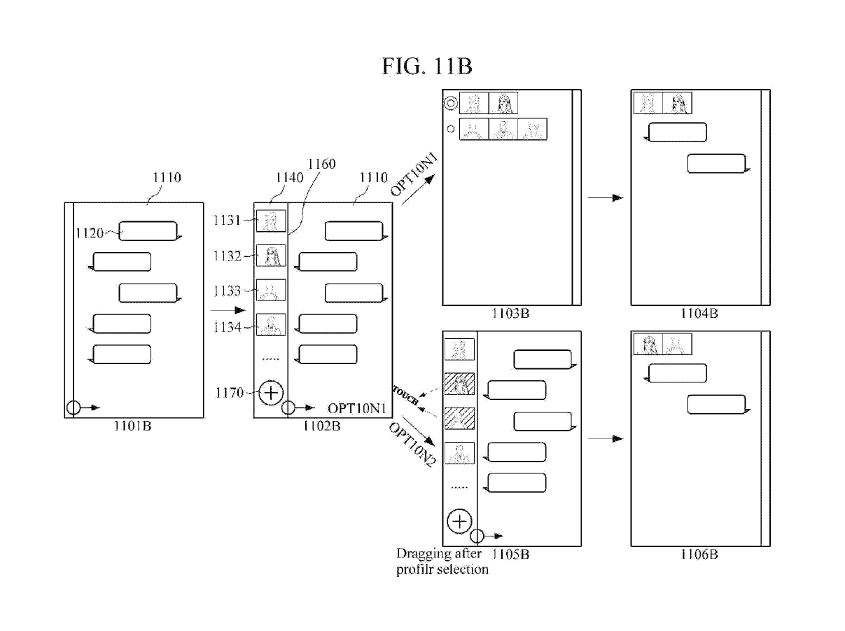

Further, the processing unit 130 updates a user interface apparatus to display the received subgroup list in the second area in operation 1007. The user may select a desired subgroup from the subgroup list displayed in the second area, and add a participant of the selected subgroup to the subgroup conversation window. Examples and description about a user interface apparatus which recalls a stored subgroup list will be provided in detail with reference to FIG. 11A.

FIG. 11A is a diagram illustrating an example of a user interface to explain a method for recalling a stored subgroup of a conversation group to retrieve the subgroup according to an exemplary embodiment of the present invention. FIG. 11A will be described as if performed by the user interface apparatus shown in FIG. 1, but is not limited as such.

Referring to FIG. 11A, the method for recalling a stored subgroup of a conversation group to retrieve the subgroup includes dragging a boundary 1160 between the first area 1110 and the second area 1140 in a right direction in operations 1101 and 1102. Speech bubbles 1120 are currently displayed in a group conversation window of the first area 1110. In order to generate a new conversation window for a subgroup or to retrieve a stored conversation window for a subgroup, the boundary 1160 between the first area 1110 and the second area 1140 is dragged to the right-hand end of the screen. The dragging direction and location of the screen may differ according to arrangement of the first area 1110 and the second area 1140 or user settings.

If there is no participant of a subgroup that is added to the second area 1140, a stored subgroup list is displayed in the second area 1140 in operation 1103. That is, if a user does not select a subgroup participant, that is, there is no added subgroup participant, a subgroup list stored in a DB 150 is displayed in the second area 1140. The stored subgroup list may include not only a list and personal information about the subgroup participants but also previous conversations performed in each subgroup. The user selects one or more subgroups from the subgroup list including one or more subgroups and configures the subgroup conversation window in operation 1104.

FIG. 11B is a diagram an example of a user interface to explain a method for managing a subgroup conversation window according to an exemplary embodiment of the present invention. FIG. 11B will be described as if performed by the user interface apparatus shown in FIG. 1, but is not limited as such.

Referring to FIG. 11B, a display screen of a group conversation window may be displayed on a touch screen in operation 1101B. The display screen may include a first area 1110 to display speech bubbles 1120 of the group conversation window. While displaying the group conversation window in the first area 1110, if a subgroup selection input is received, e.g., a touch on a left edge of the display screen and dragging the touch, the first area 1110 may be shifted and a second area 1140 may be displayed along with the first area 1110 in operation 1102B. The second area 1140 may include profiles of participants of the group conversation window. For example, the profile of each participant, e.g., name, or picture of the participant, may be displayed as selectable icons 1131, 1132, 1133, and 1134. Further, a participant addition icon 1170 may further be displayed. The selectable icons 1131, 1132, 1133, and 1134 may be displayed vertically and may be scrolled up or scrolled down to display other profiles of participants if there are many group participants in the group conversation window.

The display screen may display a boundary 1160 between the first area 1110 and the second area 1140. If a user drags the boundary 1160 to a predetermined direction without selecting a profile among the displayed selectable icons 1131, 1132, 1133, and 1134, a subgroup list may be displayed on the display screen in operation 1103B. The subgroup list may include stored subgroups of the group conversation window. The subgroup list may be associated with the group conversation window and stored in the DB 150. If the user selects a subgroup from the subgroup list in the operation 1103B, the user interface apparatus retrieves stored subgroup conversation window corresponding to the selected subgroup from the DB 150, and displays the subgroup conversation window on the display screen.

Further, if the user selects one or more profiles among the selectable icons 1131, 1132, 1133, and 1134 in the operation 1102B, the selections may be indicated in operation 1105B. For example, the selectable icons 1132 and 1133 may be touched by the user and may be toggled to indicate the selections. If the user drags the boundary 1160 to a predetermined direction after selecting at least one selectable icon, the user interface apparatus may generate a new subgroup conversation window corresponding to a subgroup including the selected profiles or retrieve a stored subgroup conversation window corresponding to the subgroup including the selected profiles in operation 1106B. For example, if the selectable icons 1132 and 1133 are selected in the operation 1105B and the boundary 1160 is dragged to a predetermined direction, a subgroup conversation window for a subgroup including the participants of the selectable icons 1132 and 1133 and the user may be generated or retrieved from the DB 150.

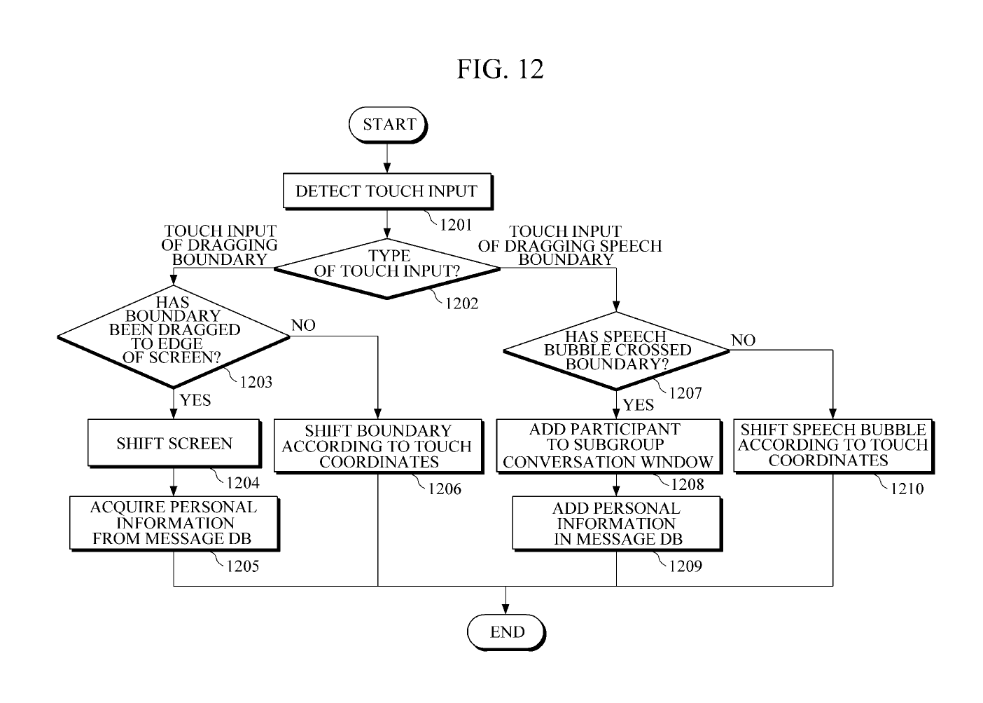

FIG. 12 is a flowchart illustrating a method for generating a subgroup of a conversation group according to an exemplary embodiment of the present invention.

Referring to FIG. 12, the method for generating a subgroup of a conversation group includes detecting a touch input in operation 1201. A touch input that is input by a user is detected using a touch input device, such as a touch screen. In addition, the detected touch input is analyzed to determine whether the touch input is to drag a boundary or a speech bubble in operation 1202. The detected touch input may be an input of dragging a boundary or an input of dragging a speech bubble. The input of dragging a boundary may include an input to shift a boundary between the first area and the second area in a left or right direction, and the input of dragging a speech bubble may include an input to shift a participant's speech bubble from the first area into the second area across the boundary.

If the touch input is an input of dragging a boundary, it may be checked whether the boundary is dragged to the edge of a screen in operation 1203. That is, if the touch input is an input of dragging a boundary, rather than an input of dragging a speech bubble, it may be determined to check whether the boundary is dragged to the edge of the screen.

If the boundary is dragged to the edge of the screen, the screen is shifted into a subgroup conversation window in operation 1204. Specifically, if the boundary is dragged to the edge of the screen, the subgroup conversation window is generated in the second area, and the user interface is shifted into the subgroup conversation window of the second area. In addition, personal information of subgroup participants is retrieved in operation 1205. Specifically, after the subgroup conversation window is generated by dragging the boundary to the edge of the screen, the personal information about the subgroup participants is acquired from a DB 150. The subgroup participants are people who are included in a previously-stored subgroup list or people who are added by a user to the subgroup. Profiles of the subgroup participants may be displayed in the subgroup conversation window based on the personal information acquired from the DB 150, so that the stored personal information of the subgroup participants may be checked in the subgroup conversation window.

If the boundary is not dragged to the edge of the screen, the boundary is shifted according to touch coordinates in operation 1206. That is, if the determination result of the operation 1203 indicates that the boundary is not dragged to the edge of the screen, the boundary is shifted to a location corresponding to the touch input. The screen may display only one of the first area and the second area or may be divided into multiple regions so as to display the first area and the second area simultaneously. Therefore, based on the location of the boundary on the screen, the first area and the second area may be displayed simultaneously and the sizes of the first area and the second area may be adjustable.

If the determination result of the operation 1202 indicates that the touch input is an input of dragging a speech bubble, it may be checked whether the speech bubble is dragged to cross the boundary in operation 1207. That is, if the touch input that is received from a user is determined as an input of dragging a speech bubble, it may be determined to check whether the dragged speech bubble crosses the boundary.

If the speech bubble crosses the boundary, a participant corresponding to the speech bubble that is added to a subgroup conversation window is also added to a corresponding subgroup in operation 1208. That is, if the speech bubble crosses the boundary, the touch input is determined as a user input to add, to the subgroup, a participant corresponding to the speech bubble. Therefore, the participant corresponding to the speech bubble is added to the subgroup by checking information about the speech bubble. In addition, the personal information of the participant who is added to the subgroup is added to a DB in operation 1209. If a new participant is added in the subgroup, a specific DB, such as an address list, is searched for to retrieve personal information about the new participant and the retrieved personal information is added in the DB 150. The personal information added in the DB 150 is used when a subgroup conversation window is generated. Therefore, using the participant's speech bubble, a user is able to directly access to the personal information of the participant.

If the determination result of the operation 1207 indicates that the speech bubble does not cross the boundary, the speech bubble is shifted along coordinates of the touch input in operation 1210. That is, if the speech bubble does not cross the boundary, the touch input is determined as an input of simply moving a location of the speech bubble, not an input of adding, to the subgroup, a participant corresponding to the speech bubble. Therefore, the corresponding speech bubble is shifted according to a location corresponding to the coordinates of the touch input. A speech bubble may be shifted for various purposes, for example, for highlighting or distinguishing a specific speech bubble.

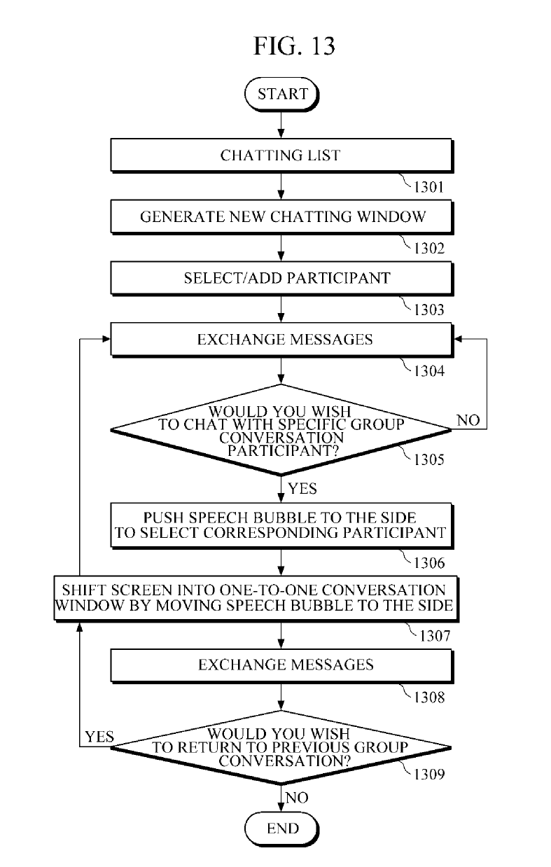

FIG. 13 is a flowchart illustrating another method for generating a subgroup of a conversation group according to an exemplary embodiment of the present invention.

Referring to FIG. 13, another method for generating a subgroup of a conversation group includes providing a chatting list in operation 1301. That is, a messenger may store a previous conversation group list and previous group conversations. A user may be provided with the chatting list including the previous conversation groups and the previous group conversations and check the chatting list.

Next, a new conversation window may be generated in operation 1302. In addition, participants are selected and added to the new conversation window in operation 1303. The new conversation window may include all people or some people who participated in the previous group conversations. In addition, people included in an address list may be added to the new conversation window. That is, the user may add participants of the new conversation window using previous group conversations, a one-to-one conversation and an address list. The user exchanges messages with the added participants via the messenger in operation 1304.

During a group conversation, it may be determined whether the user wishes to have a conversation with any specific group conversation participant by checking a user input in operation 1305. The user may wish to have a one-to-one conversation with a specific participant while having a conversation with a number of group conversation participants. If the user does not wish to have a one-to-one conversation with any specific participant, the group conversation is maintained.

If the user wishes to have a one-to-one conversation with a specific participant among group conversation participants, the specific participant's speech bubble may be selected, e.g., pushed in a predetermined direction and selected, or a touch and hold input is received on the speech bubble, in operation 1306. That is, if the specific participant's speech bubble is dragged in a predetermined direction, the corresponding participant may be selected. In addition, the group conversation window may be shifted into a one-to-one conversation window to chat with the specific participant, by pushing a screen of the group conversation window out above the side edge in operation 1307. By pushing the screen out to the side edge, it may be possible to shift from the group conversation window into the one-to-one conversation window to exchange messages with the specific participant. Next, the user may exchange messages with the specific participant in the one-to-one conversation window in operation 1308.

Next, it may be determined whether the user wishes to shift from the one-to-one conversation window into the previous group conversation window by checking a user input in operation 1309. If the user wishes to shift into the group conversation window, the screen may be pushed out to a side edge in an attempt to shift from the one-to-one conversation window into the group conversation window. If a screen is shifted, a participant list and conversations of a previous screen may be stored or maintained.

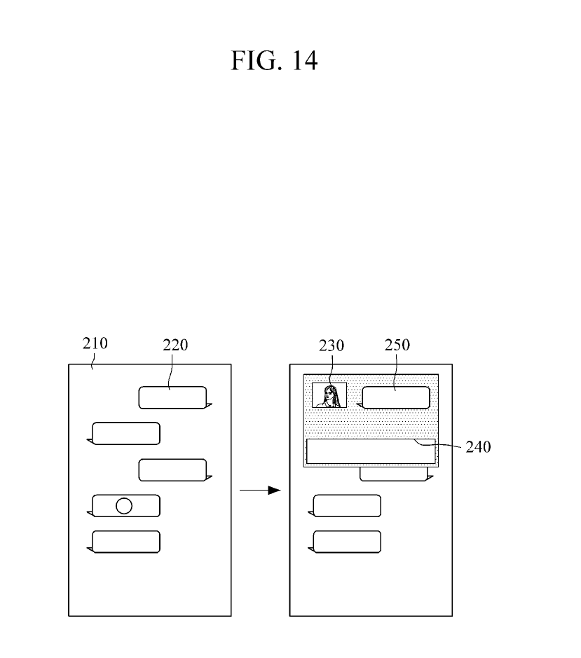

FIG. 14 is a diagram illustrating another example of a user interface for managing a subgroup of a conversation group according an exemplary embodiment of the present invention.

In the above, FIG. 2 illustrates an example of a user interface where a group conversation window and a subgroup conversation window are shifted from one another by dragging a boundary between a first area 210 and a second area 240 in a left or right direction. However, FIG. 14 shows another example of a user interface where a group conversation window and a subgroup conversation window are shifted from one another by touching a speech bubble 220 once or twice or by touching the speech bubble 220 for a long time period. The subgroup conversation window may be displayed in a manner that a new pop-up is generated above an existing window as illustrated in FIG. 14 or in a manner that the first area 210 and the second area 240 are shifted from one another as illustrated in FIG. 2.

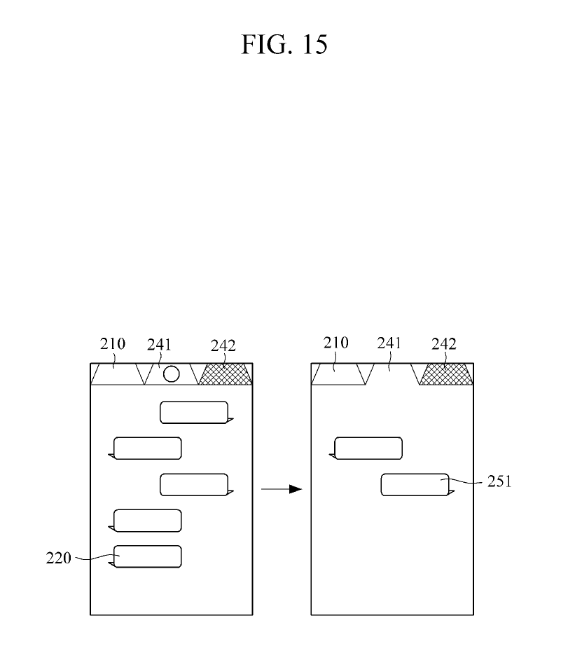

FIG. 15 is a diagram illustrating another example of a user interface for managing a subgroup of a conversation group according to an exemplary embodiment of the present invention.

In the above, FIG. 12 illustrates an example of a user interface where a boundary between a first area 210 and a second area 240 is dragged in a left or right direction so as to shift between a group conversation window and a subgroup conversation window. However, FIG. 15 shows another example of a user interface where a group conversation window 210 and a subgroup conversation window 241 are distinguished by different indexes (“selection tabs”) displayed in the upper part of the screen, and the group conversation window 210 and the subgroup conversation window 241 are shifted from one another in response to a touch of one of the indexes. The subgroup conversation window may include two or more as shown in FIG. 15 in which another subgroup conversation window 242 is included and distinguished by a distinctive index.

The above-mentioned boundary is an example of a shift interface unit of the user interface apparatus for a subgroup of a conversation group according to an exemplary embodiment of the present invention. The shift interface unit is not limited to be implemented using the boundary, but may be implemented using a user's touch input or a button. As described above, without displaying a boundary, a conversion between a group conversation window and a subgroup conversation window may be performed by a user input, such as a flicking of the display screen, selecting a conversion button, and the like.

For messenger users, a user interface apparatus and a method for a subgroup of a conversation group according to an exemplary embodiment may enhance user convenience by providing a conversion interface between a group conversation window and a subgroup conversation window.

The user interface apparatus may include a touch-sensitive display (“touch screen”) with a graphical user interface, a memory, one or more processors, a camera, and a wireless communication transceiver to support various types of wireless communications, such as Bluetooth®, Wi-Fi connect, 3^{rd} Generation wireless communication, Long Term Evolution (LTE), etc. Further, one or more modules, programs, or sets of instructions/codes may be stored in a storage device to execute the above mentioned operations and/or functions.

Aspects of the present invention may be implemented in a form of program instructions capable of being performed through various computer components to be recordable in a computer-readable recording medium (“a non-transitory recording medium”), such as a computer program product configured for execution of the instructions, and a storage of a web server configured for transmission of the program/application including the instructions. The computer-readable recording medium may include program instructions, data files, data structures, and the like or the combinations thereof. The program instructions recorded in the computer-readable recording media may be designed and constituted especially for implementing the present invention, or the type of the program instructions may be known to those skilled in a field of computer software. The computer-readable recording medium may be a magnetic medium, such as a hard disk, a floppy disk, and a magnetic tape; an optical recording medium such as a CD-ROM, a DVD, etc.; a magneto-optical medium such as a floptical disk; and a hardware device specially configured to store and perform program instructions, such as a ROM, a RAM, a flash memory, or the like. The type of the program instructions may be machine language codes that may be compiled by compilers as well as higher-level language codes capable of being executed by computers using interpreters or the like. The hardware device may be configured to be operated as one or more software modules in order to perform the process according to the present invention, and vice versa.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method, comprising:
displaying a group conversation window on a display screen of an apparatus, the group conversation window being associated with a plurality of participants;
in response to receiving a selection input, selecting a subgroup from among the plurality of participants, the selection input being received when at least part of the group conversation window is displayed on the display screen; and
displaying a subgroup conversation window associated with the selected subgroup.

2. The method of claim 1, wherein the subgroup conversation window provides a message communication among the selected subgroup and a user of the apparatus.

3. The method of claim 1, further comprising:
relocating the group conversation window in a first area of the display screen; and
displaying information of the selected subgroup in a second area of the display screen.

4. The method of claim 3, wherein the subgroup conversation window is displayed in the second area if the second area is expanded to at least part of the first area.

5. The method of claim 4, wherein a boundary between the first area and the second area is configured to be relocated by a user input associated with the boundary.

6. The method of claim 1, further comprising:
displaying information of the selected subgroup comprising a profile of a participant of the selected subgroup.

7. The method of claim 6, wherein the profile of the participant is displayed on the display screen if a touch input associated with a speech bubble of the participant is received.

8. The method of claim 1, further comprising:
retrieving one or more subgroups, each subgroup being a subgroup of the plurality of the participants and being linked to the group conversation window; and
selecting one subgroup from among the retrieved one or more subgroups.

9. An apparatus, comprising:
a touch screen display to display a group conversation window, the group conversation window being associated with a plurality of participants, and to receive a selection input, the selection input being received when at least part of the group conversation window is displayed on the touch screen display; and
a processor, in response to receiving the selection input, configured to select a subgroup from among the plurality of participants,
wherein the touch screen display displays a subgroup conversation window associated with the selected subgroup.

10. The apparatus of claim 9, wherein the subgroup conversation window provides a message communication among the selected subgroup and a user of the apparatus.

11. The apparatus of claim 9, wherein the group conversation window is relocated in a first area of the touch screen display; and
the touch screen display displays information of the selected subgroup in a second area of the touch screen display.

12. The apparatus of claim 11, wherein the subgroup conversation window is displayed in the second area if the second area is expanded to at least part of the first area.

13. The apparatus of claim 12, wherein a boundary between the first area and the second area is configured to be relocated by a user input associated with the boundary.

14. The apparatus of claim 9, wherein the touch screen display displays information of the selected subgroup comprising a profile of a participant of the selected subgroup.

15. The apparatus of claim 14, wherein the profile of the participant is displayed on the touch screen display if a touch input associated with a speech bubble of the participant is received.

16. The apparatus of claim 9, wherein the processor retrieves one or more subgroups, each subgroup being a subgroup of the plurality of the participants and being linked to the group conversation window, and
the processor selects one subgroup from among the retrieved one or more subgroups.

17. A non-transitory computer readable storage medium storing one or more programs for instructing a computer, when executed by a processor, to perform:
displaying a group conversation window on a display screen of an apparatus, the group conversation window being associated with a plurality of participants;
in response to receiving a selection input, selecting a subgroup from among the plurality of participants, the selection input being received when at least part of the group conversation window is displayed on the display screen; and
displaying a subgroup conversation window associated with the selected subgroup.

18. The non-transitory computer readable storage medium of claim 17, wherein the subgroup conversation window provides a message communication among the selected subgroup and a user of the apparatus.

19. The non-transitory computer readable storage medium of claim 17, further comprising:
relocating the group conversation window in a first area of the display screen; and
displaying information of the selected subgroup in a second area of the display screen.

20. The non-transitory computer readable storage medium of claim 17, further comprising:
displaying information of the selected subgroup comprising a profile of a participant of the selected subgroup.
